(19) United States
(12) Patent Application Publication
(10) Pub. No.: US 2014/0089067 A1
(43) Pub. Date: Mar. 27, 2014

(54) USER REWARDS FROM ADVERTISERS FOR CONTENT PROVIDED BY USERS OF A SOCIAL NETWORKING SERVICE

(71) Applicant: Google Inc., (US)

(72) Inventors: Momchil Filev, Novi, MI (US); Martin Brandt Freund, Mountain View, CA (US)

(73) Assignee: GOOGLE INC., Mountain View, CA (US)

(21) Appl. No.: 13/624,965

(22) Filed: Sep. 23, 2012

(51) Int. Cl. G06Q 30/02

(52) U.S. Cl. 705/14.19

(57) ABSTRACT

In some implementations, a method enables rewards from advertisers to users in a social networking service for content provided by the users. A method can include examining content provided by a user associated with the content in a social networking service. One or more references to one or more products or services are found in the content. The method determines an advertising effectiveness of the one or more references to users of the social networking service. The determined advertising effectiveness facilitates a determination of a reward owed to the user associated with the content.

### BACKGROUND

Social networking systems and services have become increasingly popular for use over wide-area computer networks such as the Internet. A user of a social networking service can upload and post content to the service, such as messages, pictures, videos, etc., which can be viewed by other users of the service. User-provided content often includes depictions of a variety of subjects, such as persons or users of the social network system and their surroundings performing various activities, a variety of locations and environments, objects and items owned or used by users, and so on. Content is often shared with other users of the system who may in turn share the content with many other users, leading to many different viewings or playings of the content as wells as various comments and ratings about the content across the system.

### SUMMARY

Implementations of the present application relate to enabling rewards from advertisers to users in a social networking service for content provided by the users. In some implementations, a method includes examining content provided by a user associated with the content in a social networking service. One or more references to one or more products or services are found in the content. The method determines an advertising effectiveness of the one or more references to users of the social networking service. The determined advertising effectiveness facilitates a determination of a reward owed to the user associated with the content.

Various implementations and examples of the above method are described. The content can be an image, where a reference to a product or service can include at least one depiction of the product or service in the image, and/or at least one logo denoting an advertiser for the product or service. Finding the one or more references can include examining a tag associated with the content, such as a text tag. If the content includes an image, the finding of the references can include performing object recognition on the image. The reward can include an amount of monetary value. For example, the method can determine the amount of monetary value owed to the user, including summing individual amounts of monetary value derived from different types of user access activity associated with the content.

The method can determine the advertising effectiveness of the found references in any of a variety of ways. For example, the method can determine the activity of users of the social networking service indicating user access to the content. The method can determine different types of advertising characteristics of the one or more references, such as a social connectedness of the user to other users within the social networking service and/or a presentation of the references with respect to portions of the content outside the references. The method can determine a number of users of the social networking service who have accessed the content, determine a number of times that the content has been shared with different users of the social networking service, determine a number of user comments or ratings that have been made for the content by users of the social networking service, determine a number of users of the social networking service depicted by the content and who have access to the content, and/or determine a number of purchases by users of the social networking service of the products or services, where the purchases are derived from accessing the content within the social networking service.

Determining advertising effectiveness can include determining a prominence of a reference in the content with respect to a remainder of the content outside of the reference, and/or determining a context of the one or more references in the content by examining the remainder of the content outside of the references. In one example where the content is an image, determining the prominence can include determining an area covered by the reference with respect to the total area of the image, where a larger area covered by the reference indicates a greater advertising effectiveness than a smaller area covered by the reference. Determining the prominence can include determining a position of the reference within the image, where a closer determined position to one or more predetermined positions indicates a greater advertising effectiveness than a position further from the one or more predetermined positions.

In some implementations, a method includes examining an image provided by a user to be published in a social networking service and accessed by users of the social networking service. One or more references to one or more products or services in the image and that the one or more products and services are associated with one of multiple participating advertisers. The method determines an advertising effectiveness of the one or more references to the products or services to users of the social networking service. Determining the advertising effectiveness includes determining activity of users of the social networking service indicating user access to the content. The method determines an amount of monetary value owed to the user associated with the image by the participating advertiser associated with the one or more products or services, where the amount of monetary value is based on the determined advertising effectiveness of the references to products or services.

In some implementations, a system includes a storage device and at least one processor accessing the storage device and operative to perform operations. The operations include examining content provided by a user associated with the content in a social networking service and finding one or more references to one or more products or services in the content. The operations include determining an advertising effectiveness of the one or more references to users of the social networking service, where the determined advertising effectiveness facilitates a determination of a reward owed to the user associated with the content.

In various implementations and examples of the above system, the content can be an image, and a reference to products or services can include at least one depiction of the product or service in the image and/or at least one logo denoting an advertiser for the product or service. The reward can include an amount of monetary value. For example, the system can determine the amount of monetary value owed to the user, including summing individual amounts of monetary value derived from different types of user access activity associated with the content. Determining the advertising effectiveness can include determining different types of advertising characteristics of the one or more references, such as a social connectedness of the user to other users within the social networking service, and/or a presentation of the one or more references with respect to the content. Determining the presentation can include determining a prominence of the one or more references in the content with respect to a remainder of the content outside of the references, and/or determining a context of the references in the content by examining the remainder of the content outside of the references.

### BRIEF DESCRIPTION OF THE DRAWINGS

FIG. 1 is a block diagram of an example network environment which may be used for one or more implementations described herein;

FIG. 2 is illustration of an example graphical user interface (GUI) displaying content provided by a user and examined for references to products or services according to some implementations;

FIG. 3 is a flow diagram illustrating an example method of examining user content and evaluating advertising effectiveness, according to some implementations;

FIG. 4 is a flow diagram illustrating an example method of evaluating advertising effectiveness of user content and determining rewards for users for their content, according to some implementations;

FIG. 5 is a block diagram of an example server device which may be used for one or more implementations described herein.

### DETAILED DESCRIPTION

One or more implementations described herein relate to enabling user rewards for content provided from users of a social networking service. For example, a social networking service can determine an advertising effectiveness of content provided by users by looking for references to products or services in the content. A reward is determined and owed to the user and is based on the determined advertising effectiveness. For example, a participating advertiser associated with the referenced product or service can owe and pay the reward to the user, such as an amount of monetary value.

A user can provide content such as photos or other images, text, videos, audio recordings, etc. to the social networking service to be published to users of the social networking service. The system examines the content and finds one or more references to products or services in the content. The products or services can be depicted in the content, or can be referred to indirectly via logos or brand names. In some examples, the references to product or service can be identified using an associated tag or other identifier, or the system can perform object recognition (including facial recognition) for features in image content to find the references.

The system determines an advertising effectiveness of any found references to users of the social networking service. This determination can include examination of any of several different advertising characteristics or associated data for the content. Some implementations can track and obtain access activity for the content by users on the social networking service to determine advertising effectiveness, such as the number of users of the social networking service who have accessed the content, a number of times that the content has been shared with different users of the service, a number of user comments and/or ratings that have been made for the content, and/or a number of user purchases of a referenced product or service. Some implementations can examine other advertising characteristics such as the social connectedness of the content, including the number of users who are able to access the content. Another advertising characteristic can be the presentation of the references and content to users, such as the prominence and/or context of a reference with respect to the rest of the content. For example, advertising effectiveness can be based on the amount of area covered by a reference to a product in image content, the position or location of the reference in an image, visibility and/or clarity of the reference in the content, etc.

The reward that is owed to the user is based on the advertising effectiveness of the content, and this reward can be determined by the system in some implementations. In some examples, the reward can include a sum of predetermined rewards derived from different advertising characteristics of the content. Some implementations allow advertisers to sign up with the social networking service to make payments of such rewards to users for such advertising, so that any references to products or services found in the content by the system are verified as being from an entity that has signed up to make such payments to users.

Users thus gain the ability to earn revenue or other rewards from many types of content which they are already uploading to a social networking service and with no additional effort on their part. Advertisers can promote their products and services in a very organic way that makes use of naturalistic and everyday depictions of their products and services, and can reach large audiences through a new advertising format on social networking services.

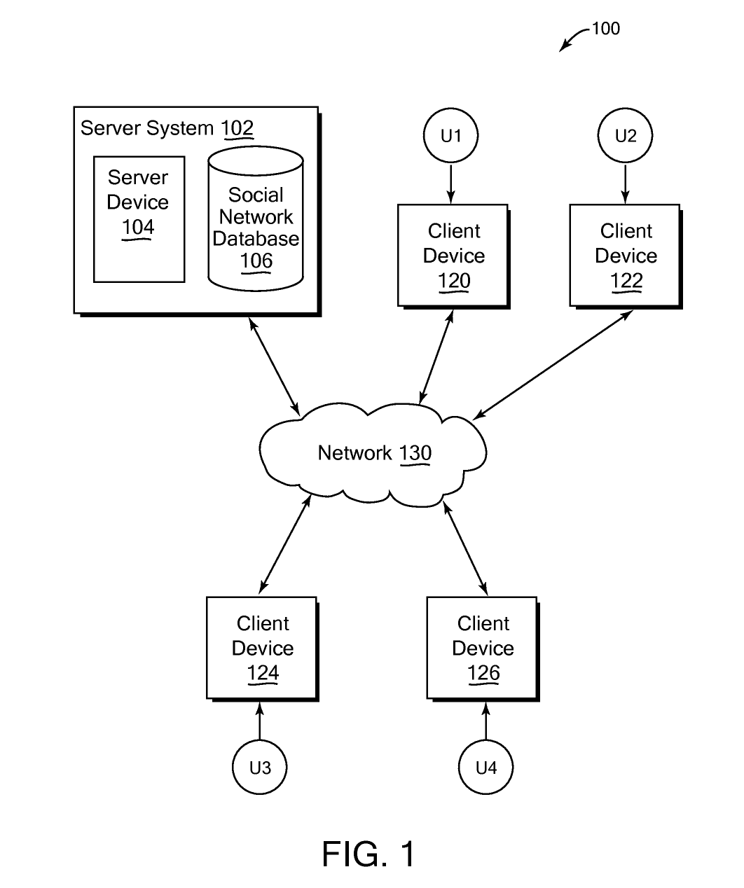

FIG. 1 illustrates a block diagram of an example network environment 100, which may be used in some implementations to provide one or more features described herein. In some implementations, network environment 100 includes one or more server systems, such as server system 102 in the example of FIG. 1. Server system 102 can communicate with a network 130, for example. Server system 102 can include a server device 104 and a social network database 106 or other storage device. Network environment 100 also can include one or more client devices, such as client devices 120, 122, 124, and 126, which may communicate with each other via network 130 and server system 102. Network 130 can be any type of communication network, including one or more of the Internet, local area networks (LAN), wireless networks, switch or hub connections, etc.

For ease of illustration, FIG. 1 shows one block for server system 102, server device 104, and social network database 106, and shows four blocks for client devices 120, 122, 124, and 126. Server blocks 102, 104, and 106 may represent multiple systems, server devices, and network databases, and the blocks can be provided in different configurations than shown. For example, server system 102 can represent multiple server systems that can communicate with other server systems via the network 130. In another example, social network database 106 and/or other storage devices can be provided in server system block(s) that are separate from server device 104 and can communicate with server device 104 and other server systems via network 130. Also, there may be any number of client devices. Each client device can be any type of electronic device, such as a computer system, portable device, cell phone, smart phone, tablet computer, television, TV set top box or entertainment device, personal digital assistant (PDA), media player, game device, etc. In other implementations, network environment 100 may not have all of the components shown and/or may have other elements including other types of elements instead of, or in addition to, those described herein.

In various implementations, end-users U1, U2, U3, and U4 may communicate with each other using respective client devices 120, 122, 124, and 126, and respective to features described herein each user can receive messages and notifications via a social network service implemented by network system 100. In one example, users U1, U2, U3, and U4 may interact with each other via the social network service, where respective client devices 120, 122, 124, and 126 transmit communications and data to one or more server systems such as system 102, and the server system 102 provides appropriate data to the client devices such that each client device can receive shared content uploaded to the social network service via the server system 102.

The social network service can include any system allowing users to perform a variety of communications, form links and associations, upload and post shared content, and/or perform other socially-related functions. For example, the social network service can allow a user to send messages to particular or multiple other users, form social links in the form of associations to other users within the social network system, group other users in user lists, friends lists, or other user groups, post content including text, images, video sequences, audio sequences or recordings, or other types of content for access by designated sets of users of the social network service, send multimedia information and other information to other users of the social network service, participate in live video, audio, and/or text chat with other users of the service, etc. As used herein, the term “social network service” can include a software and/or hardware system that facilitates user interactions, and can include a service implemented on a network system. A “social link” is any link between multiple users that allows these users to more easily communicate, view and find statuses of the other users, and/or otherwise relay information between each other. For example, adding another user to a first user's group of known users is adding a social link between these users. In some implementations, a “user” can include one or more programs or virtual entities, as well as persons that interface with the system or network.

Furthermore, a user can designate one or more user groups, such as “friends lists,” family lists, occupation lists, etc., to allow users in the designated user groups to access or receive content and other information associated with the user on the social networking service. A user's user groups each specify one or more users of the social network service with which the user has a social link. For example, the user can designate that the users in one user group can access content (e.g., receive and view the content on their client devices) which the user posts on the social networking service, such as text or audio messages and graphical images. Or, the user can designate that the users in a different user group can access user profile information of the user, such as identifying information, opinions, hobbies, interests, etc. In some implementations, the access of users to user information can be designated in terms of larger groups, such as a “public” setting designating all the users of the social network service, “acquaintances” to indicate friends of friends, or a different privacy level setting. Some implementations of a social networking service allow the user to designate groups of users including extended or additional social linked levels (degrees of separation) of users. For example, a first user may be able to designate that a second or extended linked level of users, such as friends of the user's friends, are able to access the first user's information and content, which in this example can be any users that have at least one of the friends of the first user in their own user groups. A user may also be able to designate other groups or sets of users regardless of whether those other users are in the user's own listed groups. For example, the user may designate users belonging to a designated group or list, or having one or more specified characteristics, such as age, membership in a designated organization, eye color, designated hobbies or interests, member of a designated organization since a particular time or date, etc.

A social networking interface, including display of content and communications, privacy settings, notifications, and other features described herein, can be displayed using software on the client device, such as application software or client software in communication with the server system. The interface can be displayed on an output device of the client device, such as a display screen. For example, in some implementations the interface can be displayed using a particular standardized format, such as in a web browser or other application as a web page provided in Hypertext Markup Language (HTML), Java™, JavaScript, Extensible Markup Language (XML), Extensible Stylesheet Language Transformation (XSLT), and/or other format.

Other implementations can use other forms of network systems instead of social networking services and systems. For example, a set of users and other entities using any computer network can make use of features described herein.

Some implementations can provide communications to one or more “advertisers” that have agreed to and are associated with making payments of rewards to users in features described herein. Such advertisers can be any entity, such as a person, business, organization, computer system, etc. The advertiser can be an entity directly referred to or associated with referenced products or services in the user content, and/or can be agents of or tangentially associated with such an entity. In some implementations, some or all of the advertisers participating in the payments to users can have systems with connections to the social network service via network 130 to send and receive information related to features herein.

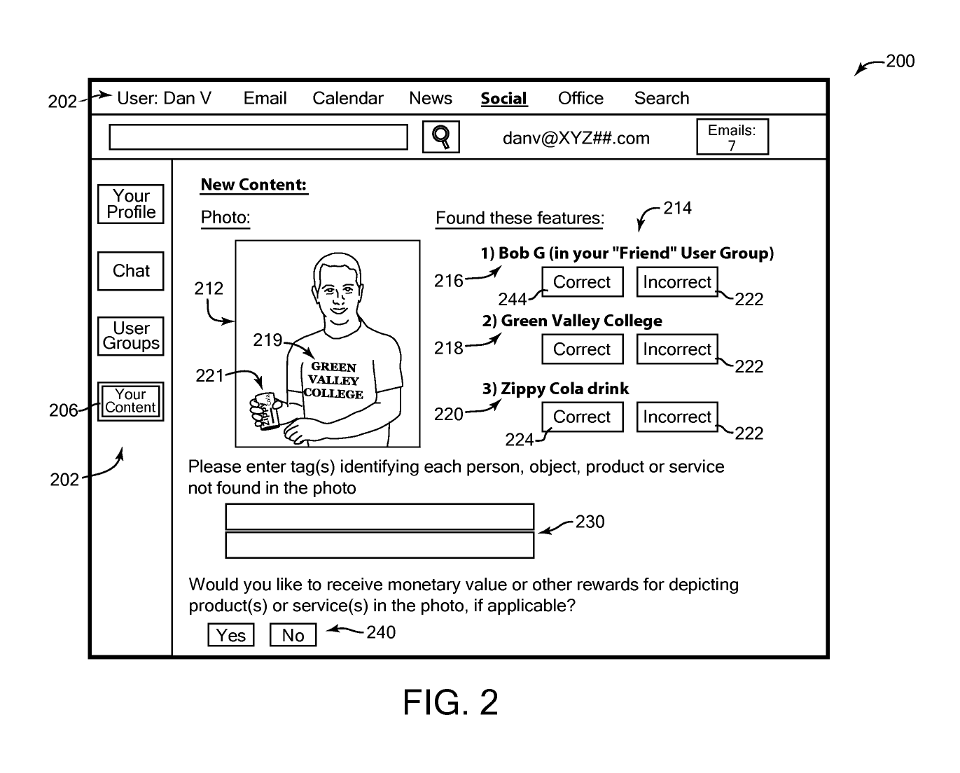

FIG. 2 is a diagrammatic illustration of an example simplified graphical interface (GUI) 200 displaying content provided to a social networking system and examined for references to products or services according to some implementations. GUI 200 can be displayed on a display device, e.g., of a client device 120, 122, 124, and/or 126, or a server system 102 in some implementations. For example, the GUI 200 can be downloaded from the server system 102 for display on a client device in a web browser or other application program. The interface 200 includes one or more displayed windows within the GUI, or can be displayed in other forms in other interfaces. In the present example, an active user is viewing information his or her own account on the social networking service.

In some implementations, the interface 200 can include a number of choices presented in a menu bar 202. In the present example, the “Social” choice has been selected by the active user to select a social network interface. This selection causes, for example, a web-based social networking application to be executed and a social network menu 204 to be displayed. The social network menu 204 can include functions to display the active user's profile information, communication options such as chat, or content provided from other users such as those users in user groups designated by the active user. In this example, an option 206 can cause the user's content to be displayed, such as photo albums, messages, comments, or other content.

In the current example, the system displays new content in a content area 210 of the interface 200. The content can be stored on one or more storage devices accessible to the social network service, such as on the social network database 106. This content has been determined by the system to be new to the active user's account. For example, the active user may have uploaded the content to the social networking service, or otherwise provided the content for his or her account, and thus is the “providing user” for the content. In the example of FIG. 2, the content is a digital image 212, such as a photograph taken by a camera. In one example, the account of active user “Dan V” is being viewed, who is the providing user that has uploaded the photo 212 from a client device to his account or user profile of the social networking service implemented on server system 104. Other types of content can also be provided and displayed on the content area 210 (or controls displayed to play such content), such as text content, video content, or audio content.

The content area 210 also displays suggested descriptions 214 of objects and references which have been identified by the system as being depicted in the new content. Depicted objects can include faces, people, locations, articles or items, etc. According to implementations described herein, the system can identify “references” to particular products or services. These references can be depicted objects that by their nature exhibit a brand or otherwise refer to an advertiser. For example, a car of a particular make and model can be identified, which refers to a brand and company associated with that make and model. A reference can also be a logo, such as a text logo and/or a pictorial logo. For example, a close-up image of a car logo would not provide any car object to identify, but the logo is a reference identifying a brand name. Some identified objects may not be considered references, such as people in the content having no discernible connection to a particular product, service, or advertising entity.

The system can identify the objects and references using any of a variety of techniques. In some examples, the system can identify references and objects by examining identifiers (or other metadata) associated with the content. For example, the active or other providing user may have input information into one or more tags associated with a photo image, such as names of persons or other objects depicted in the photo. These tagged objects are identified by the system via the tags. Tags can be displayed in the content area 210 with the content in some implementations (not shown in FIG. 2). In some implementations, other metadata besides tags can be associated with the content, such as comments or ratings from other users of the social network system or links to other content, and this associated metadata may be able to be used to assist in identifying objects and references depicted in the content.

In some implementations, the system can perform object recognition on the content to identify objects and references in the content. For example, if the new content is an image 212, a depicted object can include a face of a user of the social networking system that is recognized using facial recognition techniques. Such facial recognition techniques may be able to more readily identify faces of people who are users of the social networking service. Object recognition techniques other than facial recognition techniques can also be used to recognize any types of objects, including landmarks, landscape or location features, vehicles, tools, food, clothing, devices, or other items or objects. In some examples, the system can use an object recognizer that can provide keywords based on analysis of the content. The keywords can be provided in different degrees of precision and have different confidences, e.g., the more precise the description the less confident the recognition. For example, a vehicle object in photo content can be described by several keywords including, “vehicle,” “car,” the make of the car, and the model of the car, where each keyword is successively more precise and less confident. In some implementations, one or more of such keywords can be presented in the interface 200 as a description 214 or other identification of an object in the content. Some implementations can employ character recognition techniques to identify writing in visual content, which can be used to recognize brand names or logos as well as help identify objects in the content.

The displayed descriptions 214 can list suggestions of each object found and identified in the content. In the example of FIG. 2, a first description 216 describes the person depicted in the image 212 as “Bob G”, a user of the social networking system and a member of one of the active user's user groups, who may have been identified using facial recognition and/or examining a tag associated with the photo and listing the name. A second description 218 describes a reference to a college institution or entity, which was identified from writing 219 on the depicted person's shirt. A third description 220 describes a reference to a brand of a soda drink 221 that the depicted user is holding in the image 212.

Furthermore, one or more displayed options can allow the providing user to confirm whether the suggested objects are correctly identified and/or identified to the desired degree of precision. In the example of FIG. 2, each description 214 is associated with two displayed buttons, one button 222 for allowing the user to indicate that the object was correctly identified, and another button 224 for indicating an incorrect identification (or a too vague or broad identification). In some implementations, if the user selects the “incorrect” button option 224 for one of the descriptions 214, then a field or other input area (not shown) can be displayed to allow the user to correct the associated description by inputting a different or more detailed description of the identified object. For example, if the system identifies a depicted soda drink as the wrong brand, the user can input the correct brand in an entry field displayed next to or near the associated reference 214. Or, if the system cannot identify a soda drink in more detail than “drink cup or can,” or a car cannot be identified in more detail than a “car,” the user can be prompted to input more details, such as the exact brand and/or type of drink or exact model of car.

Input fields 230 can be displayed in some implementations to allow a user to input identifications of objects or references to products, services, or brand names which were not identified by the system. Advertising option 240 can be displayed in some implementations to allow the active user to select whether he or she wishes to receive rewards from advertisers for references to products or services in the user's content, as per features described herein. A user can decide to opt in or out of the advertising reward feature at any time.

After the user confirms and/or modifies the identified objects and references in the content 212, the system can publish the content on the social networking service if the content is not already so published. The advertising effectiveness of the content can be determined and a reward to the user determined, as described in greater detail below.

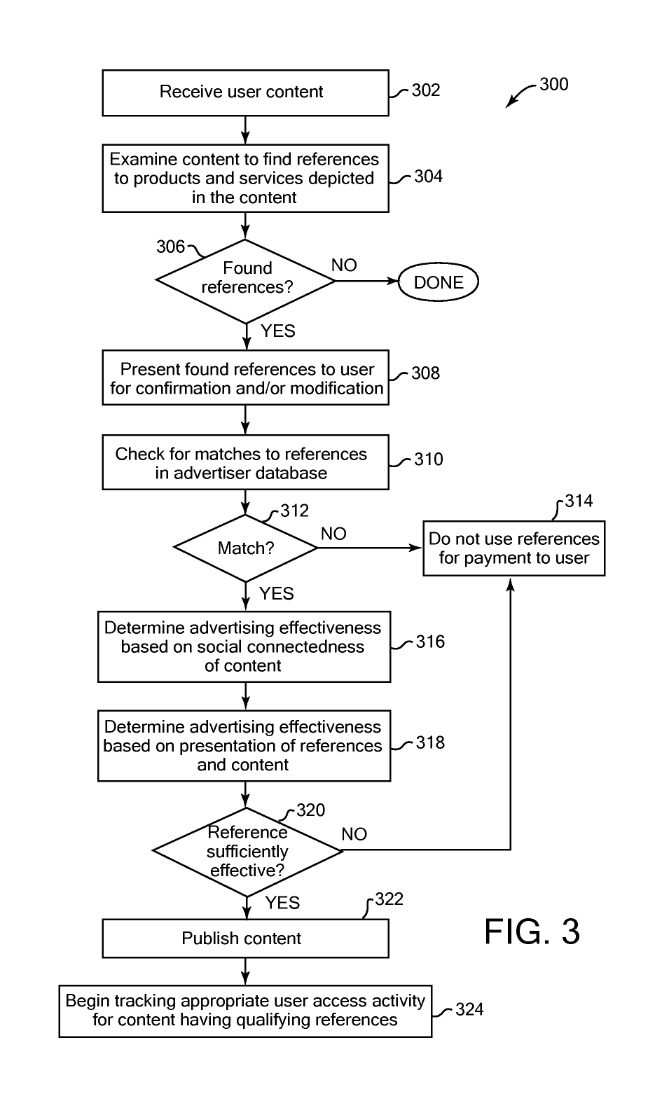

FIG. 3 is a flow diagram illustrating one example of a method 300 of enabling user rewards from advertisers for content provided by users of a social networking service. In some implementations, method 300 (and method 400, below) can be implemented, for example, on a server system 102 as shown in FIG. 1. In described examples, the server system includes one or more processors or processing circuitry, and one or more storage devices such as a database 106. In some implementations, different components of a server and/or different servers can perform different blocks or other parts of the method 300. In other implementations, some or all of the method 300 can be implemented on one or more client devices. Method 300 can be implemented by program instructions or code, which can be implemented by one or more processors, such as microprocessors or other processing circuitry and can be stored on a computer readable medium, such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. Alternatively, these methods can be implemented in hardware (logic gates, etc.), or in a combination of hardware and software. The method 300 can be provided as part of or component of an application running on the client device, or as a separate application or software running in conjunction with other applications and operating system.

In block 302 of method 300, the social networking service receives user content. The content constitutes digital data and can be any type of content, such as text, image, video, audio, or a combination of these or other types. In some embodiments, the content can include other information such as geographical locations at which one or more users of the network system are currently or recently located, map information, graphs, biometric information, etc. The content can be stored on one or more storage devices accessible to the social network service, such as on the social network database 106. The content is associated with a particular providing user that provided the content to the social networking service, such as uploading the content to the system from any of client devices 120-126 or other system, selecting the content on an accessible storage system, etc. Some implementations allow the providing user to upload the content to a user profile or account associated with the providing user in the social networking service.

In some implementations, the user content can be new to the system in the sense that the content has not before been examined for the features described herein. For example, the content may have just been uploaded or designated by the providing user and the content may have previously been scanned by the system for other features or purposes before block 302 is performed. In some examples, the system may have selected the content for examination after scanning for new content in user accounts, albums, or other storage.

In block 304, the system examines the content to find references to products and services present in the content. A reference can be any indication of a particular brand of product or service. For example, in some implementations, the system examines the content to find and identify objects depicted in the content, where an object can be one form of reference to a product or service. Depicted objects can include faces, people, landscape features, devices, or any other physical objects. A reference to a product or service can also or alternatively be a logo, brand name or trademark, such as a text brand name or a pictorial logo. Such a logo may or may not be associated with a depicted object. For example, image content depicting a close-up view of a logo may not provide any object to identify, but the logo itself provides a brand-name and can be a reference to an advertiser.

As described above with reference to FIG. 2, references to products and services can be found and identified in any of multiple ways. In some examples, the system can identify references and objects by examining tags, identifiers, or other metadata associated with the content. The system can, in some implementations, identify references by performing object recognition on the content to identify objects in the content, or having another system perform such recognition, such as facial recognition or other types of object recognition techniques as described above. Such object recognition techniques can, in some implementations, consult large databases of features to find matches to common objects and other features. Some implementations of social networking services may run object recognition processing on content for other purposes, and the process 300 can obtain those recognized results for use with the features described herein.

In block 306, the process checks whether any references to one or more products or services were found from the examination of block 304. If not, the process is complete and the content is processed normally by the social networking service, e.g., published (if not already done so) and/or stored in system storage. If one or more references have been found, then in block 308 the system presents the found references to the providing user in a social networking interface for confirmation and/or modification by the user, such as the example displayed interface 200 of FIG. 2. This allows the user to see the suggestions provided by the system as to which references to products and services are present in the content based on system identification techniques. In some implementations, the user can designate each suggested reference as correct or as incorrect, e.g., the user approves or disapproves. One example of this is described above with reference to FIG. 2, with the system displaying descriptions of identified references and/or objects in the content and options to confirm as correct or indicate as incorrect. The incorrect option can include suggestions that are wrong or otherwise improper, such being as too broad, vague or only partially correct.

If a suggested reference is designated as improper by the providing user, then in some implementations the user can be given an opportunity to modify the reference to a form deemed acceptable to the user. In some examples, the user can input information replacing the suggested reference, modifying a portion of the suggested reference, or providing additional detail. Some implementations can display an entry field or other input area to allow the user to input a correct or more detailed description of the identified object.

In block 310, the system checks data in an advertiser database for matches to the identified, user-approved references. The advertiser database stores information indicating which products and services qualify for rewards to users if those products and services are depicted in user content. In some implementations, the advertiser database can store data for those advertisers that have agreed with the social networking service to pay rewards to users based on advertising effectiveness of references to those advertisers' products or services in the content of users of the social networking service. The advertisers can be, for example, entities such as persons, businesses, or other organizations. For example, the advertiser database can list the advertisers and brand names for the advertisers' products and services for which the advertisers will provide rewards to users of the social networking service.

In some examples, the system can check for matches of identified brand names. For example, if a particular identified reference is for a particular brand name of soda, the system can check the advertiser database for a listing of that same brand name. Some implementations can also check for matches to particular types of products or services offered by the advertisers, such as a canned soda drink rather than a bottled soda drink in the same example. In some examples, some advertisers or systems may require that an identified reference match both a particular product or service type and one or more particular brand names to qualify as a match. For example, an identified reference may be considered a match if it includes a brand name of a particular company as well as a particular type of product such as “car.” Other requirements can alternatively be provided for what constitutes a match.

In block 312, the process asks whether any of the references in the content match products, services, or brand names in the advertiser database. If there is no match, then in block 314 the process determines that none of the found references in the user content are to be a basis for payments of advertising rewards to the user, and the process is complete.

If one or more references did match listings in the advertiser database, then the system can evaluate and determine an advertising effectiveness of each of the matched references found in the content in the following blocks 316 and 318. In these blocks, an advertising effectiveness of a found reference can be evaluated and determined immediately based on different types of advertising characteristics, such as social connectedness of the content (block 316) and/or the presentation of the reference and content (block 318). In some implementations, such advertising effectiveness can be expressed as one or more ratings or scores relative to a predetermined scale.

In block 316, an advertising effectiveness can be determined based on the social connectedness of the content, indicating a social influence of the content. The social connectedness can establish an advertising effectiveness based on how likely the content is to be shared or distributed to other people, such as other users of the social networking system. For example, the system can evaluate social connectedness and determine a social connectedness rating by examining the number of users who will have access to the content. This can be determined in some implementations by examining the number of social user contacts or linked users of the providing user. For example, the user groups of the providing user can be examined to determine the number of users of the social networking service in those groups that will have access to the content, which may include groups such as friend groups, family groups, company or business groups, etc. If the providing user has not yet specified which groups or users have access to the content, then in some implementations block 316 can be delayed until after the user has done so, or a default user access level can be used.

In some implementations, the social connectedness rating of the product and service references can be determined or influenced based on one or more persons depicted in the content. For example, in some implementations, if a person depicted in the content is a user of the social networking service, then the social contacts of the depicted user can be examined to determine users who are likely to see the advertising reference in the content. For example, in some implementations if the depicted user has access to the content, one or more of that user's social contacts may also have access, depending on the depicted user's settings on his account or other preferences. The number of users as social contacts who will or are likely to have access can be counted by the system to determine social connectedness rating of the content.

In addition, the number of users depicted in the content can influence the social connectedness rating of the content. For example, if image content depicts five people, all of whom have been recognized by the system to be users of the social networking service, then social contacts of each of these depicted users can be examined and likely viewers of the content can be added to the total number of users likely to view the content. In some implementations, the actual number of users who will have access can be determined, and/or some implementations can estimate a number of users who will have access based on average number of user contacts or other measure. In some implementations, the system can provide a weighting factor to the social connectedness rating, where the number of depicted users influences that rating.

In block 318, an advertising effectiveness of the found references can be determined in some implementations based on the influence of the presentation of the references and the content. The system can examine the content to determine how effectively the advertising references are presented to viewers, e.g., determine a presentation rating. Various presentation characteristics can be examined. One example is the prominence of a reference to a product or service within the content and with respect to the remainder of the content outside the reference. For example, a position or location of the reference can be determined for advertising effectiveness. In some examples, the system can examine particular predetermined positions of the content and evaluate the position of the reference relative to those predetermined positions. For example, one predetermined position can be the center of the area of an image, and the closer to the center of the image that the reference is located, the better a prominence rating assigned to that reference. References located close to the corners of an image can be assigned a worse prominence rating. In some implementations, the position of the reference can be evaluated with respect to particular content or features found in the content. For example, it may be known that a viewer's eyes are first attracted to a human face in an image. The system can assign a greater prominence rating to an advertising reference that is closer to a human face than to a reference that is further from such a face. Other content can be similarly emphasized, where positions closer (in space and/or time) to a feature of initial focus of a viewer or listener, or main subject of the content, are given a better prominence rating than positions further from that focus feature.

In other examples of determining a prominence of an advertising reference, the area covered by a reference in an image can be compared to the total area of the image. The higher the area covered, the better the prominence rating assigned to the reference. Similarly, the more time a particular reference is shown and/or output relative to the entire presentation time of the content, the better the prominence rating assigned to that reference. In some implementations, a number of occurrences of an advertising reference can influence the prominence. For example, a particular brand name that occurs two times in an image can have a greater total prominence rating than a single larger occurrence of the brand name that happens to cover the same area of the image as the two occurrences.

Another presentation characteristic for determining advertising effectiveness can include a context of an advertising reference with respect to the remainder of the content outside the reference. The system can evaluate whether the context of the reference is effective or not and determine an appropriate context rating. For example, an advertising reference of a particular brand of soda drink can be considered to have a better context rating if the soda drink can is held by a smiling person depicted in the content rather than a frowning person or person with neutral demeanor. The presence of smiles, laughs, sadness, or other emotions of people in the content can be determined using the facial recognition techniques mentioned above, and the determined emotions can be considered in the context for the advertising reference based on known and generally-accepted preferences. Similarly, another example of a better context rating can be for an environment that is generally considered pleasing by most people, such as a scene of natural beauty in wilderness, as opposed to a scene generally considered less attractive, such as a heavily dark and industrial scene.

Such estimations of context rating for content can be provided or assisted by an object recognition engine which can recognize objects and features in images and provide data to evaluate context based on recognized objects. Some systems may have access to evaluation methods in which large amounts of previously-recorded data is available indicating trends in user reactions and survey answers when experiencing content (such as data obtained from users of the social network system). Such methods can determine a quality rating for content, including how favorable particular content subjects may generally be as based on previous user reactions and surveys.

In some implementations of method 300, an advertiser can specify to the social networking service preferences as to how to determine such advertising effectiveness ratings. For example, an advertising can specify which methods to use to determine prominence ratings, or which contexts should be considered more favorable for a particular brand, product, or service. For example, the advertiser can specify that an ocean scene or beach scene in an image is the most favorable context for references to its sunscreen lotion products. The advertiser preferences can override any used generally-accepted preferences to determine the ratings. Such advertiser preferences can be stored, for example, in the advertiser database or other storage accessible to the system.

In some implementations, the results of both blocks 316 and 318 can be combined to determine an estimated advertising effectiveness of each found reference to products or services in the content. Some implementations can assign ratings to one or more of the social connectedness and presentation factors for a reference, can weight the ratings in a particular way, and/or can combine the ratings to determine a combined advertising effectiveness rating of the reference in the content. In some implementations, the weighting of the ratings can vary for each different reference and/or content being examined, based on advertiser preferences, characteristics of the referenced product or service and content, system characteristics, known behavior of users on the social networking system, or other factors. In some examples, a particular advertiser may want to have social connectedness weighted much more than presentation in determining advertising effectiveness. A different advertiser may want to have prominence of presentation weighted more than context of presentation. A particular type of product may be known from previous user reaction data to be more effectively advertised the more people view it, and so social connectedness can be weighted more heavily for references to such a product. User purchasing behavior on the social network system can be tracked by the system and correlated and clustered with advertising effectiveness such that the system knows that particular advertising factors are more effective, and can automatically weight those factors more heavily.

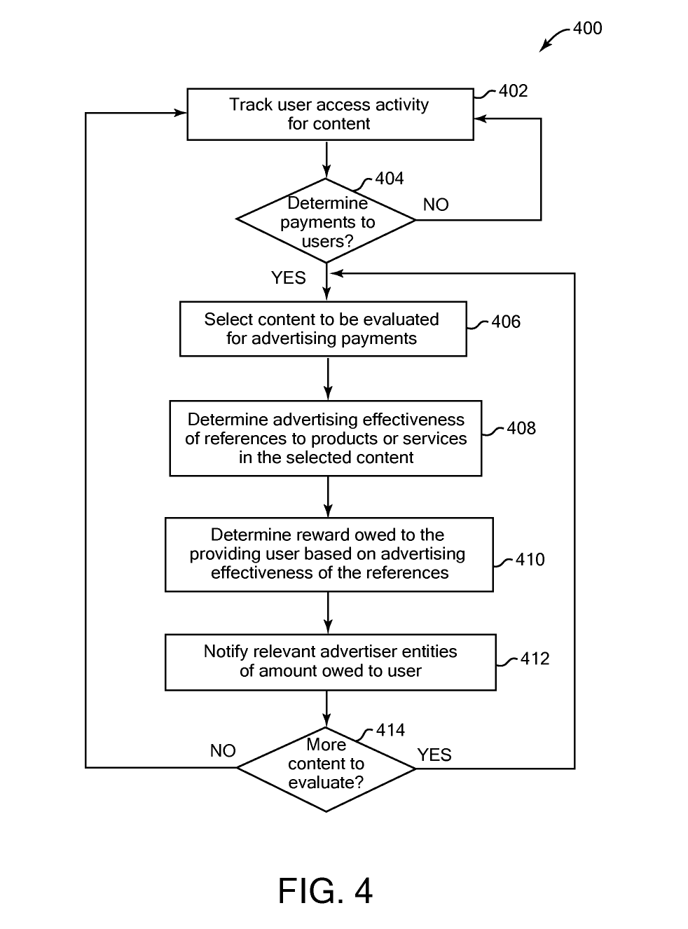

In an optional block 320, the process can check if the determined advertising effectiveness is sufficient to allow the content to qualify for payment to the providing user. For example, in some implementations, the social networking service or a particular advertiser may require that, for content to be eligible for payments, the reference in that content must have a minimum advertising effectiveness combined rating as based on the determination in the preceding blocks. References that do not have such a minimum rating are ineligible. Other tests can be used to determine sufficient advertising effectiveness to qualify for payments. If there is insufficient effectiveness for a reference as found in block 320, then the process continues to block 314 where the reference is not used as a basis for payment to the user. If a reference does qualify with sufficient advertising effectiveness, then the process continues to block 322. In some implementations, the check for reference qualification in block 320 can be performed at a different time or stage, such as when determining a payment for the user as described below with respect to FIG. 4.

In block 322, the content can be “published” or shared on the social network service and made viewable (or otherwise accessible) by other users. The set of users who have access to the content is or was previously designated by one or more users, such as the providing user of the content. For example, the content can be published to user groups of friends and family of the providing user. In some implementations, the content may have already been published before this point in the process, in which case this block 322 can be skipped.

In block 324, the system may begin tracking user access activity to content having one or more qualifying references in the social networking service. A variety of user access activities associated with the content can be tracked in various implementations. The user access activities can include views or plays of the content by users of the service. For example, the system can count each time that users view or play the content in a social networking interface. Another tracked access activity can be the sharing of the content to additional users. For example, the system can track each time that users share access to the content to another user that did not previously have access to that content. Another tracked access activity can be comments and/or ratings for the content added by users. For example, the system can track each comment and rating associated with the content contributed by users other than the providing user. Another access activity can be user purchases (e.g., known by or made via the social networking service) of a product or service associated with references in the content. For example, the system can track the purchase of any product or service associated with a brand name stated in the reference, and/or can track the purchase of a specific product or service depicted in the content. Other activities can also be tracked in some implementations, such as the number of times the content is featured in social events or communications on the system, linked to by external programs or presentations (web pages, documents, etc.), or other activities indicating that users have seen or experienced the content. These activities indicate another type of advertising effectiveness of the reference in the content and in some implementations can influence the determination of payment owed to the user, as described below with reference to FIG. 4.

In some implementations, each user of the social networking service is given an option as to whether he or she wants his or her access activities associated with content to be tracked for determination of advertising effectiveness and/or user payments as described herein. For example, the system can be implemented to only track the access activity of users that have agreed to such tracking in block 324. In some implementations, only particular users or subsets of users of the service are tracked for their access activity to the content, based on user- or system-specified criteria. For example, some implementations can allow the providing user to select or designate the particular users or user groups whose access activities are to be tracked.

Variations of method 300 can be implemented. For example, the blocks can be performed in a different order than shown in FIG. 3, and/or simultaneously where appropriate. In some implementations, advertising effectiveness ratings based on social connectedness and/or presentation of content can be determined later than shown in method 300. For example, in some implementations these forms of advertising effectiveness can be determined at the stage in the process as the determination of the tracked advertising effectiveness of content or determination of reward, as described below with respect to FIG. 4.

Some implementations can provide a reward owed to a user based on the current advertising effectiveness determined in blocks 316 and/or 318 and without the use of tracked records of user access activity. For example, an initial payment can be provided to the user upon the determination of the combined advertising effectiveness from blocks 316 and 318. Such a payment can be determined similarly as described below with reference to FIG. 4.

Some implementations can also optionally determine one or more advertisements from advertisers to display to users of the social networking service in association with the content. For example, the references to products and services and objects and that are identified in the content in block 304 can be used to determine which related advertisements from an advertiser database can be displayed. In some implementations, such advertisements can be displayed to the providing user during the methods 300 and 400 and/or to other users who access the content. Some implementations can provide a purchase opportunity of a depicted product or service to users selecting the content to view or play, or to users selecting an advertisement in connection with the content.

FIG. 4 is flow diagram illustrating one example of a method 400 of evaluating advertising effectiveness of user content and determining rewards for users based on their content. In some implementations, method 400 can be implemented, for example, on a server system 102 as shown in FIG. 1, or other suitable hardware and/or software system similarly as described above for method 300 of FIG. 3.

Method 400 continues from block 324 of method 300 in FIG. 3. In block 402, the system tracks user access activity over time with respect to pieces of content having one or more references to advertiser products or services. Some implementations can only track content having qualifying references as described above with reference to FIG. 3. In some implementations, as described above with reference to block 324 of FIG. 3, tracking the user access activity can include tracking a variety of different particular user activities in the social networking service, such as tracking the number of views or plays of the content by users, the number of times the content is shared to users, the number of times that the content is commented on and/or rated by users, and/or other activities indicating that users have seen or experienced the content. This tracked user access activity can form tracked advertising effectiveness data for each reference to a product or service in the tracked content.

In block 404, the system checks whether payments of rewards based on user content should be determined for any of the users or content of the social networking service. For example, some implementations can determine payments periodically, such as every week or every month. The payments can be determined periodically after the content is published, or on predetermined periodic dates. Some systems can determine when to determine payments based on other criteria, such as after particular events associated with the content, associated with the user, and/or associated with the system. For example, payments can be determined in response to a predetermined number of users having accessed the content, in response to an associated advertiser requesting the payment determination, and/or in response to other predetermined requirements or events. If no payments are to be determined, then the process returns to block 402 to continue tracking user access activity related to the content.

If the process finds in block 404 that payments are to be determined, then in block 406 the process selects content to be evaluated for advertising payments. In some implementations, the content can be selected based on amount of time since the content was published or was last evaluated for payments to the user. In some examples, all qualifying content of all the users of the system, or particular subsets of users of the system, can be evaluated. In the example of FIG. 4, one of the content pieces of a user is selected for evaluation at block 406.

In block 408, the system determines a payment advertising effectiveness for each reference in the selected content, which is the advertising effectiveness used to determine a payment in block 410 below. In some implementations, this can include obtaining the tracked advertising effectiveness data that specifies user access activity tracked in block 402. Such activity data indicates past user activity related to the content, how many users are likely to have experienced the product or service reference, and how many times the reference was experienced. For example, the process can retrieve the total number of views of the content by users, the total number of times the content was shared to other users, the total number of user comments and ratings made to the content, and the total number of purchases by users of the referenced product or service to establish the payment advertising effectiveness. These totals can track the amount of user activity since the last estimation of advertising effectiveness and/or last payment to the providing user was determined or made by the system. In some implementations, advertising effectiveness ratings determined based on the social connectedness of the content and/or based on the presentation of the content and references, as in blocks 316 and 318 of FIG. 3, can be obtained and used to influence the payment advertising effectiveness. For example, these ratings can establish whether the content qualifies for payment, as described above for block 320 of FIG. 3. In some implementations, these ratings can be used to influence the amount of payment owed to the user, as described below.

In block 410, the system determines a reward owed to the providing user based on the advertising effectiveness determined for the content. In some implementations, this reward can be determined based on the data indicating the tracked user activity associated with the content. Some implementations can determine the amount of rewards by summing individual rewards derived from different types of user access activity associated with the content. Furthermore, different types of user access activity can be weighted as desired by an advertiser or the system. For example, a different predetermined rate of payment can be established for each type and occurrence of user activity tracked, with optional minimum amounts of activity necessary to qualify for payment. In one specific example, rates previously agreed upon by the advertiser and social network service can stipulate that a user will receive $0.05 for every 1,000 views of the content by users, $0.15 for every 1,000 times that the content is shared to other users, $5.00 for every 500 comments on the content made by users other than the providing user, and $10.00 for every 10 purchases of a product or service associated with the found reference in the content. Other examples can provide incremental payments for smaller numbers of user accesses, such as 1 cent for each time a user provides a comment. In another example, the amount of payment can be increased non-linearly for larger amounts of tracked user activity associated with the content. In some implementations, the user activity that qualifies for payment determination is the user activity tracked in the time period since the last payment to the user was made based on this content.

Some implementations can influence the amount of payment to the user or payment rates based on other advertising characteristics. In some examples, these characteristics can include different types of advertising effectiveness ratings, such as the ratings for social influence or connectedness, presentation influence, and/or combined ratings of those types, as described with respect to FIG. 3. In some examples, a system can determine different predetermined reward amounts for references based on their having a rating higher than one or more predetermined threshold ratings. For example, $1.00 can be added to the payment for each advertising effectiveness rating over a first particular threshold, and $2.00 can be added for a rating over a second, higher threshold. Some implementations can use the advertising effectiveness ratings to influence the rate of payment made for the tracked user access activity (described above). For example, content having a brand name reference to a product that has a larger rating for prominence of the reference can be given a higher payment rate, such as $0.20 per 1,000 times the content is shared instead of $0.15. Similarly, content having a higher social connectedness rating can be given a higher payment rate.

In some implementations, an advertiser associated with a product or service reference can stipulate different payment rate adjustments based on each of that advertiser's products or services, and based on other factors including the particular content type (e.g., image, video, or audio), the subject of the content (e.g., persons, landscape, objects), and various types of advertising effectiveness ratings as described herein. In some embodiments, the payment rates can be influenced based on characteristics such as the amount of user activity for the content that has occurred over a longer period of time and not just the time period since the last user payment was made. For example, a payment rate can be increased if the content has been shown to be consistently popular with users and have large amounts of user activity (e.g., over a predetermined threshold) for a longer period of time, such as the entire time period since the selected content was first published.

The reward owed to the user can take any of a variety of forms in various implementations. For example, the reward can be an amount of monetary value, such as money in a real currency, and/or can be a form of exchange in other or additional forms, such as a proprietary or system-limited currency, exchangeable tokens or credits, IOUs, coupons redeemable for items of value, etc. The reward can be an item, product or service, such as one or more free physical products, virtual bonuses or products having value within a computer-implemented environment, free use of a service for a particular length of time, or other form of reward. The reward can be provided in a virtual form, such as virtual currency, credits, or items, or in a physical form, such as physical money or products.

In some implementations, the system does not determine the particular reward payment owed to users providing the content. For example, the system can provide one or more different types of data to an advertiser so that the advertiser can determine the payment according to advertiser rules and preferences. In one example, the social networking system can provide data such as the content and the descriptions of the found references to that advertiser's products and services, as well as providing advertising effectiveness data such as tracked user access activity and/or advertising effectiveness ratings based on social connectedness and/or presentation of the content and references.

In block 412, the system notifies the relevant advertiser entity or entities of the reward owed to the user based on the selected content. In various examples, this notification can be an invoice to the advertiser, a response to a prompt from the advertiser, or other type of notification. In some implementations the advertiser can provide payment to the user or can provide payment to the social networking service which is transferred to the user. In some implementations, the social network service can provide the owed reward to the providing user of the selected content, e.g., providing an amount of monetary value to an electronic account of the user or in some other form of payment, and can be reimbursed by the advertiser for any such payments made to users. In some implementations, the social networking service can receive a fee or predetermined portion of the payment for itself, e.g., as compensation for providing the environment for user content advertising.

In block 414, the process checks whether there is additional user content to evaluate for payment to users. If so, the process returns to block 406 to select content for evaluation for payment. If there currently is no additional content to evaluate, the process returns to block 402 to continue tracking user access activity for user content.

It should be noted that the blocks described in the methods of FIG. 3 and FIG. 4 can be performed in a different order than shown and/or simultaneously (partially or completely) with other blocks, where appropriate. In some implementations, blocks can occur multiple times, in a different order, and/or at different times in the methods.

In other implementations, variations of one or more above features can be used. For example, some implementations may provide multiple different systems collecting advertising effectiveness data and providing such data to a central system or repository for analysis and payment determination. In some other implementations, one or more of the client devices can perform one or more functions of the server, instead of or in addition to the server performing those functions.

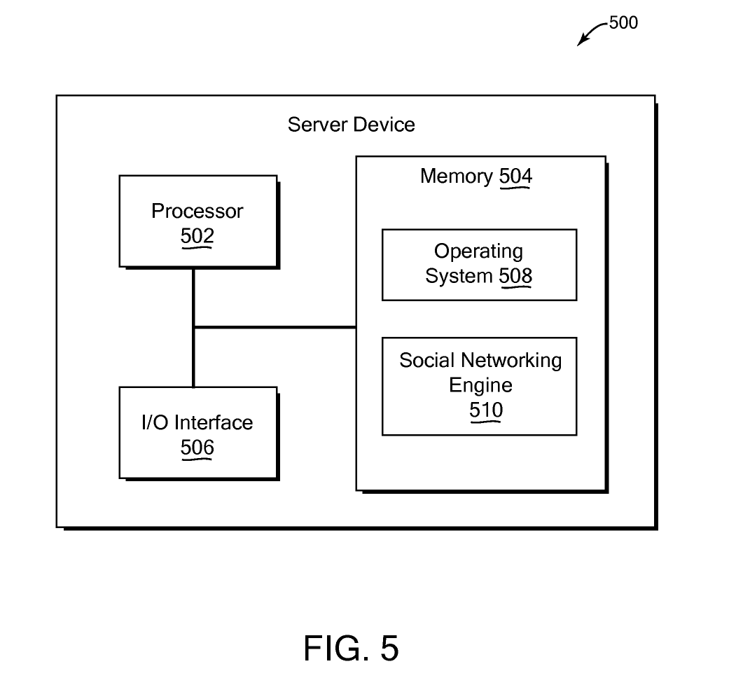

FIG. 5 is a block diagram of an example server device 500, which may be used to implement some implementations described herein. For example, server device 500 may be used to implement server device 104 of FIG. 1, and perform appropriate method implementations described herein. Server device 500 can be any suitable computer system, server, or other electronic or hardware device. For example, the server device 500 can be a mainframe computer, desktop computer, workstation, portable computer, or electronic device (portable device, cell phone, smart phone, tablet computer, television, TV set top box, personal digital assistant (PDA), media player, game device, etc.). In some implementations, server device 500 includes a processor 502, a memory 504, and input/output (I/O) interface 506.

Processor 502 can be one or more processors or processing circuits to execute program code and control basic operations of the device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is typically provided in device 500 for access by the processor 502, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on the server device 500 by the processor 502, including an operating system 508 and a social networking engine 510. In some implementations, the social network engine 510 can include instructions that enable processor 502 to perform the functions described herein, e.g., some or all of the methods of FIGS. 3 and 4. Any of software in memory 504 can alternatively be stored on any other suitable storage location or computer-readable medium. In addition, memory 504 (and/or other connected storage device(s)) can store privacy settings, content, and other data used in the features described herein. Memory 504 and any other type of storage (magnetic disk, optical disk, magnetic tape, or other tangible media) can be considered “storage devices.”

I/O interface 506 can provide functions to enable interfacing the server device 500 with other systems and devices. For example, network communication devices, storage devices such as memory and/or database 106, and input/output devices can communicate via interface 506. In some implementations, the I/O interface can connect to interface devices such as input devices (keyboard, pointing device, touchscreen, microphone, camera, scanner, etc.) and output devices (display device, speaker devices, printer, motor, etc.).

For ease of illustration, FIG. 5 shows one block for each of processor 502, memory 504, I/O interface 506, and software blocks 508 and 510. These blocks may represent one or more processors or processing circuitries, operating systems, memories, I/O interfaces, applications, and/or software modules. In other implementations, server device 500 may not have all of the components shown and/or may have other elements including other types of elements instead of, or in addition to, those shown herein. While system 102 is described as performing steps as described in some implementations herein, any suitable component or combination of components of system 102 or similar system, or any suitable processor or processors associated with such a system, may perform the steps described.

A client device can also be used with features described herein, such as client devices 120-126 shown in FIG. 1. Example client devices can include some similar components as the server device 500, such as processor(s) 502, memory 504, and I/O interface 506. An operating system, software and applications suitable for the client device can be provided in memory and used by the processor, such as client group communication application software. The I/O interface for a client device can be connected to network communication devices, as well as to input and output devices such as a microphone for capturing sound, a camera for capturing images or video, audio speaker devices for outputting sound, a display device for outputting images or video, or other output devices. A display device, for example, can be used to display the settings, notifications, and permissions as described herein, where such device can include any suitable display device such as an LCD, LED, or plasma display screen, CRT, television, monitor, touchscreen, 3-D display screen, or other visual display device. Some implementations can provide an audio output device, such as voice output or synthesis that speaks text in ad/or describing the settings, notifications, and permissions.

Although the description has been described with respect to particular implementations thereof, these particular implementations are merely illustrative, and not restrictive. Concepts illustrated in the examples may be applied to other examples and implementations.

Note that the functional blocks, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed such as procedural or object-oriented. The routines may execute on a single processing device or multiple processors. Although the steps, operations, or computations may be presented in a specific order, the order may be changed in different particular implementations. In some implementations, multiple steps or blocks shown as sequential in this specification may be performed at the same time.

What is claimed is:

1. A method comprising:
examining an image provided by a user to be published in a social networking service and accessed by users of the social networking service;
finding one or more references to one or more products or services in the image and that the one or more products and services are associated with one of a plurality of participating advertisers;
determining an advertising effectiveness of the one or more references to users of the social networking service, wherein determining the advertising effectiveness includes determining activity of users of the social networking service indicating user access to the content; and
determining an amount of monetary value owed to the user associated with the image by the participating advertiser associated with the one or more products or services, wherein the amount of monetary value is based on the determined advertising effectiveness of the one or more referred products or services.

2. A method comprising:
examining content provided by a user associated with the content in a social networking service;
finding one or more references to one or more products or services in the content; and
determining an advertising effectiveness of the one or more references to users of the social networking service, wherein the determined advertising effectiveness facilitates a determination of a reward owed to the user associated with the content.

3. The method of claim 2 wherein the content is an image, and wherein the one or more references to one or more products include at least one of:
at least one depiction of the one or more products or services in the image; and
at least one logo denoting an advertiser for the one or more products or services.

4. The method of claim 2 wherein finding the one or more references includes examining a tag associated with the content, wherein the tag includes text.

5. The method of claim 2 wherein the content includes an image, and wherein finding the one or more references includes performing object recognition on the image.

6. The method of claim 2 wherein determining the advertising effectiveness includes determining activity of users of the social networking service indicating user access to the content.

7. The method of claim 2 wherein determining the advertising effectiveness includes determining different types of advertising characteristics of the one or more references including one or more of:
a social connectedness of the user to other users within the social networking service; and
a presentation of the one or more references with respect to portions of the content outside the one or more references.

8. The method of claim 2 wherein determining the advertising effectiveness includes at least one of:
determining a number of users of the social networking service who have accessed the content; and
determining a number of times that the content has been shared with different users of the social networking service.

9. The method of claim 2 wherein determining the advertising effectiveness includes determining a number of user comments or ratings that have been made for the content by users of the social networking service.

10. The method of claim 2 wherein determining the advertising effectiveness includes determining a number of users of the social networking service depicted by the content and who have access to the content.

11. The method of claim 2 wherein determining the advertising effectiveness includes determining a prominence of the one or more references in the content with respect to a remainder of the content outside of the references.

12. The method of claim 11 wherein the content is an image, and wherein determining a prominence of the one or more references includes one or more of:
determining an area covered by the one or more references with respect to the total area of the image, wherein a larger area covered by the one or more references indicates a greater advertising effectiveness than a smaller area covered by the one or more references; and
determining a position of the one or more references within the image, wherein a closer determined position to one or more predetermined positions indicates a greater advertising effectiveness than a position further from the one or more predetermined positions.

13. The method of claim 2 wherein determining the advertising effectiveness includes determining a context of the one or more references in the content by examining the remainder of the content outside of the references.

14. The method of claim 2 wherein determining the advertising effectiveness includes determining a number of purchases by users of the social networking service of the one or more products or services, wherein the purchases are derived from accessing the content within the social networking service.

15. The method of claim 2 wherein the reward includes an amount of monetary value, and further comprising determining the amount of monetary value owed to the user, wherein determining the amount includes summing individual amounts of monetary value derived from different types of user access activity associated with the content.

16. A system comprising:
a storage device; and
at least one processor accessing the storage device and operative to perform operations comprising:
examining content provided by a user associated with the content in a social networking service;
finding one or more references to one or more products or services in the content; and
determining an advertising effectiveness of the one or more references to the one or more products or services to users of the social networking service, wherein the determined advertising effectiveness facilitates a determination of a reward owed to the user associated with the content.

17. The system of claim 16 wherein the content is an image, and wherein the one or more references to one or more products include at least one of:
at least one depiction of the one or more products or services in the image; and
at least one logo denoting an advertiser for the one or more products or services.

18. The system of claim 16 wherein the reward includes an amount of monetary value, and further comprising determining the amount of monetary value owed to the user, wherein determining the amount includes summing individual amounts of monetary value derived from different types of user access activity associated with the content.

19. The system of claim 16 wherein determining the advertising effectiveness includes determining different types of advertising characteristics of the one or more references including one or more of:
a social connectedness of the user to other users within the social networking service; and
a presentation of the one or more references with respect to portions of the content outside the one or more references.

20. The system of claim 16 wherein determining the advertising effectiveness includes at least one of:
determining a prominence of the one or more references in the content with respect to a remainder of the content outside of the references; and
determining a context of the one or more references in the content by examining the remainder of the content outside of the references.
